(19) United States
(12) Patent Application Publication
(10) Pub. No.: US 2026/0105319 A1
(43) Pub. Date: Apr. 16, 2026

(54) COMPUTING TECHNOLOGIES FOR REAL-TIME HYPERPARAMETER TUNING OF MACHINE LEARNING TRAINING PROCESSES VIA LANGUAGE MODELS

(71) Applicant: Positronic AI, LLC, Ballwin, MO (US)

(72) Inventors: Justin Hofer, Webster Groves, MO (US); Charles Kyle, Ellisville, MO (US); Evan Young, St. Louis, MO (US); Ben Vierck, Ballwin, MO (US)

(21) Appl. No.: 19/360,775

(22) Filed: Oct. 16, 2025

Related U.S. Application Data
(60) Provisional application No. 63/708,059, filed on Oct. 16, 2024.

(51) Int. Cl. G06N 3/0985; G06N 3/082

(52) U.S. Cl. CPC G06N 3/0985; G06N 3/082

(57) ABSTRACT

This disclosure solves various technological problems described above by using language models (LMs) (e.g., large, small) to enable an autonomous adjustment algorithm that performs hyperparameter optimization within an active training session, with minimal or no human oversight. Resultantly, these improvements improve computer functionality by enabling more efficient hyperparameter searching by improving model performance, efficiency, scalability, time-to-market, and cost savings.

### CROSS-REFERENCE TO RELATED PATENT APPLICATION

This patent application claims a benefit of priority to U.S. Provisional Patent Application 63/708,059 filed 16 Oct. 2024, which is incorporated by reference herein in its entirety for all purposes.

### TECHNICAL FIELD

This disclosure relates to Language Models (LMs), such as large LMs (LLMs).

### BACKGROUND

Existing data science methodologies for hyperparameter optimization are severely limited in their ability to effectively and efficiently tune hyperparameters in real-time, within an actively training machine learning model. As these approaches are based on specifying a single value for the entire duration of a training session, these approaches lack the ability to react to changing situations during a training session. For instance, a high learning rate and low dropout may be critical for getting a model to fit early during training, but later epochs may be better suited by a higher dropout and lower learning rate in order to properly fine tune the model and avoid overfitting.

Model Training: the training process includes iteratively updating a model's internal parameters through the application of optimization algorithms that guide the minimization of a loss function computed by comparing predictions made by the model against actual output values in the training subset. The performance of these optimization algorithms is heavily dependent on a set of hyperparameters that control the algorithms' behaviors, such as learning rates, batch sizes, and regularization strengths. Current methods of tuning hyperparameters are managed manually by the data scientist. Outside of rare cases, this tuning happens before a training session starts, and is only changed after that session ends. At a high level, the workflow is illustrated in FIG. 1 and looks like this: at the end of each training iteration, or epoch, the data scientist typically examines the relevant metrics that result from the evaluation of the model using the validation data to determine if the model is learning sufficiently. If the data scientist decides that an intervention is necessary, then the data scientist may stop the training session, modify various hyperparameters to control the learning dynamics, and influence the model's behavior, and then restart training. Such modifications can include adjusting hyperparameters, such as learning rate, batch size, and momentum, which impact the speed and stability of convergence; modifying regularization strengths and types to control overfitting and feature selection; and fine-tuning data augmentation techniques to artificially expand the training dataset. These strategic interventions allow the data scientist to adaptively refine the model's architecture and optimize its performance on unseen data. In order to make these adjustments, the data scientist must perform a rigorous analysis of all of the relevant metrics produced by the training process up to this point, diagnose what, if any interventions can be taken to improve the learning, and to execute those interventions.

General Limitations: the current widely accepted methodology of tuning hyperparameters involves halting a running training session, changing the desired hyperparameters as a result of analysis of the evaluation metrics up to this point, then starting a new session. The process is slow and time-consuming, and cannot actively adapt to changing conditions. Typically, weights are not reloaded, the session is restarted from scratch, and the training process to return to this point needs to be rerun.

Limitations over Prolonged Time: as training sessions extend beyond a few days or even weeks, the practicality of data scientists monitoring and responding to changes in metrics becomes severely limited. The constraints of being a 24-hour, non-renewable resource hinder their ability to provide real-time oversight and intervention.

Previous Attempts to Solve this Technical Problem: recognizing the limitations of human oversight during prolonged model training, some researchers have developed various techniques to automate the optimization process and minimize lost opportunity costs. One such approach is the use of Learning Rate Schedulers, which dynamically adjust the learning rate over time in response to changes in the training metrics. By incorporating scheduling algorithms that adaptively modify the learning rate based on factors, such as epoch number, plateaus, or performance degradation, such systems aim to strike a balance between exploration and exploitation, guiding the model towards optimal convergence without requiring continuous human supervision. Additionally, some algorithms implement an Early Stopping Strategy that takes into account a “patience” period, where the algorithms allow the training process to continue for a certain number of epochs even if there is no significant improvement in performance. This approach helps prevent premature termination of the training process due to minor dips or fluctuations.

Key Factors Preventing Technical Solutions: previously proposed solutions, including Learning Rate Schedulers and Early Stopping Strategies, have shown promise in specific contexts, but are not universally applicable or scalable. These approaches often rely on heuristics, assume a fixed problem setting, or overlook the complex interactions between the hyperparameters and the underlying data distribution. Some technical challenges that have hindered others from solving these technical problems include various technical limitations. For example, until very recently, the context lengths of LMs have been too small to accommodate the amount of information required to make intelligent changes to a running training session. Further, efficiently scaling hyperparameter tuning to large complex neural network architectures is difficult. Additionally, developing methods that can adapt in real-time to changing conditions, such as shifting data distributions or emerging patterns, is still an open research question. Moreover, despite their promise, LMs have limitations, including a propensity for generating incorrect responses that resemble accurate information, aka, hallucinations. These hallucinations are time-consuming to deal with, because of time/resources spent to develop strategies to minimize these hallucinations (e.g., carefully prompting the messages with targeted information that was at risk of being hallucinated otherwise). Also, analyzing the training of a machine learning model is a difficult task requiring specialized knowledge, especially since some LMs were not trained on data containing conversations about machine learning.

### SUMMARY

This disclosure solves various technological problems described above by using LMs (e.g., large, small) to enable an autonomous adjustment algorithm that performs hyperparameter optimization within an active training session, with minimal or no human oversight. Resultantly, these technical improvements improve computer functionality by enabling more efficient hyperparameter searching by improving model performance, efficiency, scalability, time-to-market, and cost savings. For example, in context of improving model performance, hyperparameters significantly affect the accuracy and reliability of machine learning models. As such, optimal hyperparameter values can lead to better prediction results, improved decision-making, and enhanced customer experiences. For example, in context of efficiency, automated hyperparameter search enables companies to optimize their models for performance while minimizing computational resources, reducing costs, and speeding up development times. For example, in context of scalability, as data volumes grow, the time required to analyze, diagnose, and come up with hyperparameter interventions optimization becomes increasingly time-intensive. Companies that can replace human hyperparameter optimization with AI can scale their operations more effectively. For example, in context of time-to-market, by taking the human out of the loop of the hyperparameter search, companies can take advantage of gains in model performance that might result from adjusting hyperparameters during extended training sessions, even when humans are not actively monitoring the process. For example, in context of cost savings, by automating hyperparameter tuning, companies can reduce the costs associated with manual model development, training, and maintenance. Additionally, companies can realize cost-savings by avoiding wasted computation. Often, long-running processes occur over periods of time where there is minimal or no human monitoring, i.e. weekends and holidays. If one of these long-running processes encounters a challenge where it stops learning until some adjustment is made to “get over the hump”, then any computation that occurs from that time until the intervention is wasted compute time. Therefore, minimizing or taking humans out of the loop can result in significant cost savings over time. As such, entities that can efficiently manage their hyperparameters during training can gain a competitive edge by delivering better customer experiences, reducing costs, and accelerating their growth. Therefore, usage of a LM, such as an LLM, to analyze and modify an ongoing training session, improves computer functionality.

An embodiment of a method to use a LM to analyze and modify an ongoing training session may include a multi-step process, where an LM agent (e.g., a chatbot, an Application Programming Interface (API)) analyzes a currently training machine learning model and suggests changes to its hyperparameters that are then iteratively applied to the hyperparameters while the machine learning model is still training. For example, the multi-step process may include during an ongoing training session, at the end of each epoch, initiate a separate analysis process with all recorded relevant metrics up to this point; the analysis process views a log of all relevant metrics, hyperparameters, and prior interventions and extracts meaningful measurements and observations from this raw data; measurements and observations are transformed from raw data into parsable sentences and paragraphs; the sentences and paragraphs are fed into a LM (e.g., an LLM) based agent (e.g., a chatbot, an API) along with the imperative (e.g., a prompt, an instruction, a query) to suggest changes; the LM agent suggests changes to the current hyperparameters; the suggestions are error checked; if suggestions are made, then the suggestions are applied (e.g., in real-time) to the most recent iteration of the model, otherwise end here if no changes are necessary; ongoing training session is halted; new training session restores saved weights and other relevant data, alongside changed hyperparameters; and the training session is continued as if the training session had never been interrupted. If no changes are necessary or after the training session is continued, then the multi-step process loops or iterates to continue from beginning.

An embodiment of a system comprises a computing instance programmed to run an autonomous adjustment algorithm that performs a hyperparameter optimization process within an active training session.

### DESCRIPTION OF DRAWINGS

FIG. 1 shows a flowchart of an example of a process of training a machine learning model.

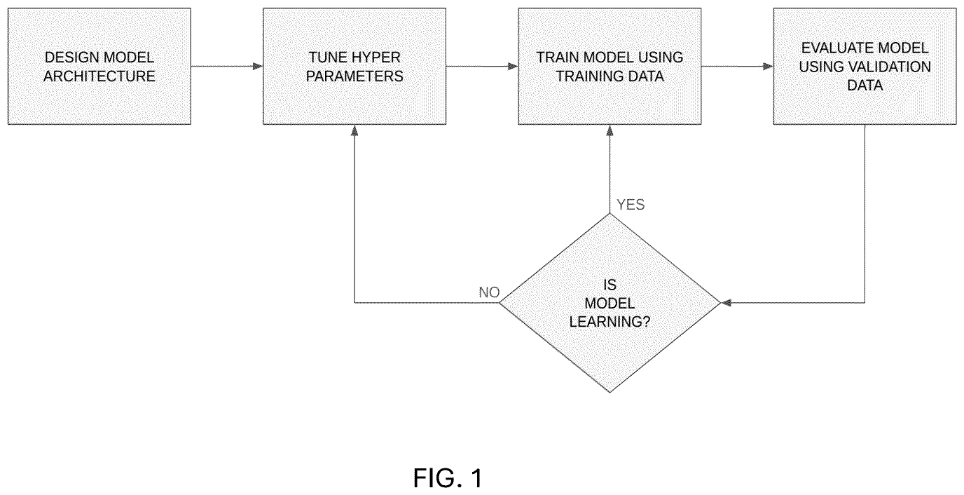

FIG. 2 shows a flowchart of an example of a process of training a machine learning model involving a language model according to this disclosure.

FIG. 3 shows a screenshot of an example of a plot having an epoch X-axis and a value loss Y-axis according to this disclosure.

FIG. 4 shows a diagram of an example of a computing architecture according to this disclosure.

### DETAILED DESCRIPTION

As described above, this disclosure enables an LM-driven “autopilot” for training machine learning models: during training, an agent built on a language model (or the LM itself) watches the run, diagnoses fit/overfit/underfit from logs of each epoch, recommends concrete hyperparameter changes, pauses the run to apply them (while preserving weights/state), and then resumes training—repeating this loop automatically. This approach solves the technical problem of traditional hyperparameter tuning that is mostly static and human-in-the-loop: you pick values up front, run an epoch (or many), stop, analyze plots/metrics, tweak, and start again. That wastes time/compute and can't react to mid-run drift (e.g., you might want high learning rate/low dropout early and the opposite later). By using the LM as a supervisory agent (or the LM itself) that, at the end of each epoch, is fed with a linguistically-framed summary of current/recent training and validation metrics; the agent responds with actionable, structured recommendations (e.g., JSON) to adjust hyperparameters and, optionally, model structure. These changes are applied mid-training by pausing, editing the configuration, restoring saved weights/optimizer state, and resuming from the same point—so the run continues as if uninterrupted, but under the updated settings, which further improves functioning of computers that perform machine-learning training by reducing compute wasted on non-learning epochs, lowering wall-time to convergence, and increasing utilization through in-run policy control (pause/persist/restore/resume). Therefore, this approach is technologically advantageous because the LM operates like “cruise control” for training machine learning models, where the LM as the supervisory agent monitors your training metrics every epoch, decides what to tweak, pauses just long enough to apply the change without losing your weights, and keeps going (it can even roll back to a safer epoch or add layers if you're underfitting—all automatically).

This disclosure is now described more fully with reference to all attached figures, in which some embodiments of this disclosure are shown. This disclosure may, however, be embodied in many different forms and should not be construed as necessarily being limited to various embodiments disclosed herein. Rather, these embodiments are provided so that this disclosure is thorough and complete, and fully conveys various concepts of this disclosure to skilled artisans. Note that like numbers or similar numbering schemes can refer to like or similar elements throughout.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

As used herein, a term “or” is intended to mean an inclusive “or” rather than an exclusive “or.” That is, unless specified otherwise, or clear from context, “X employs A or B” is intended to mean any of natural inclusive permutations. That is, if X employs A; X employs B; or X employs both A and B, then “X employs A or B” is satisfied under any of the foregoing instances. For example, X includes A or B can mean X can include A, X can include B, and X can include A and B, unless specified otherwise or clear from context.

As used herein, each of singular terms “a,” “an,” and “the” is intended to include a plural form (e.g., two, three, four, five, six, seven, eight, nine, ten, tens, hundreds, thousands, millions) as well, including intermediate whole or decimal forms (e.g., 0.0, 0.00, 0.000), unless context clearly indicates otherwise. Likewise, each of singular terms “a,” “an,” and “the” shall mean “one or more,” even though a phrase “one or more” may also be used herein.

As used herein, each of terms “comprises,” “includes,” or “comprising,” “including” specify a presence of stated features, integers, steps, operations, elements, or components, but do not preclude a presence or addition of one or more other features, integers, steps, operations, elements, components, or groups thereof.

As used herein, when this disclosure states herein that something is “based on” something else, then such statement refers to a basis which may be based on one or more other things as well. In other words, unless expressly indicated otherwise, as used herein “based on” inclusively means “based at least in part on” or “based at least partially on.”

As used herein, terms, such as “then,” “next,” or other similar forms are not intended to limit an order of steps. Rather, these terms are simply used to guide a reader through this disclosure. Although process flow diagrams may describe some operations as a sequential process, many of those operations can be performed in parallel or concurrently. In addition, the order of operations may be re-arranged.

As used herein, a term “response” or “responsive” are intended to include a machine-sourced action or inaction, such as an input (e.g., local, remote), or a user-sourced action or inaction, such as an input (e.g., via user input device).

As used herein, a term “about” or “substantially” refers to a +/−10% variation from a nominal value/term.

As used herein, a term “locale” refers to a standard language locale definition but where a language identifier (e.g., en, es) is required and a region identifier (e.g., US, ES) is optional.

Although various terms, such as first, second, third, and so forth can be used herein to describe various elements, components, regions, layers, or sections, note that these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section, without departing from this disclosure.

Unless otherwise defined, all terms (including technical and scientific terms) used herein have the same meaning as commonly understood by skilled artisans to which this disclosure belongs. These terms, such as those defined in commonly used dictionaries, should be interpreted as having a meaning that is consistent with their meaning in context of relevant art and should not be interpreted in an idealized or overly formal sense, unless expressly so defined herein.

Features or functionality described with respect to certain embodiments may be combined and sub-combined in or with various other embodiments. Also, different aspects, components, or elements of embodiments, as disclosed herein, may be combined and sub-combined in a similar manner as well. Further, some embodiments, whether individually or collectively, may be components of a larger system, wherein other procedures may take precedence over or otherwise modify their application. Additionally, a number of steps may be required before, after, or concurrently with embodiments, as disclosed herein. Note that any or all methods or processes, as disclosed herein, can be at least partially performed via at least one entity or actor in any manner.

Hereby, all issued patents, published patent applications, and non-patent publications that are mentioned or referred to in this disclosure are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

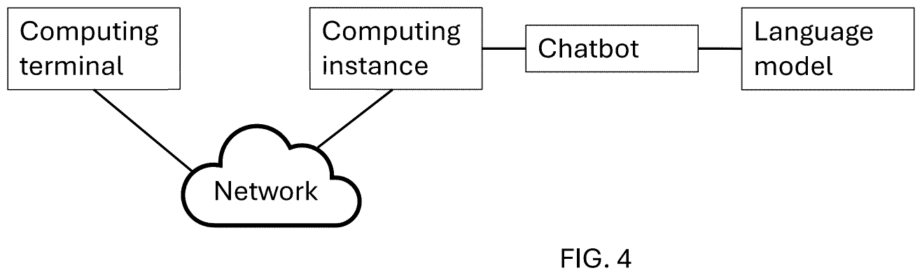

As shown in FIG. 4, there is a computing architecture containing a network, a computing terminal, a computing instance, a chatbot, and a LM. The computing instance contains a server or a set of servers. The chatbot is optional and may be omitted.

The network is exemplified as a wide area network (WAN), but may be a local area network (LAN), a cellular network, a satellite network, or any other suitable network. For example, the network may be embodied as or include Internet. Although the network is a single network, this configuration is not required and the network can be a group or collection of suitable networks collectively operating together in concert to accomplish various functionality, as disclosed herein.

The computing terminal is exemplified as a desktop computer, but may be a laptop computer, a tablet computer, a wearable computer, a smartphone, or any other suitable computing form factor. The computing terminal hosts an operating system (OS) and an application program on the OS. For example, the OS may include Windows, MacOS, Linux, or any other suitable OS. Likewise, the application program may be a browser program (e.g., Microsoft Edge, Apple Safari, Mozilla Firefox) or any other suitable application, which is operable (e.g., interactable, navigable) by a user of the computing terminal. The computing terminal may be in communication (e.g., wired, wireless, waveguide) with the computing instance, the chatbot, or the LM over the network. For example, such communication may occur via the application program running on the OS, as explained above. The computing terminal is separate and distinct from the computing instance, the chatbot, or the LM.

The computing instance is exemplified as a computing service or unit containing the server (e.g., physical or virtual) or the set of servers (e.g., physical or virtual) programmatically acting in concert, any of which may be a web server, an application server, a database server, or another suitable server, to enable various algorithms disclosed herein. For example, via the server or the set of servers, the computing instance may be enabled in a cloud computing service (e.g., Amazon Web Services (AWS)) as a service-oriented-architecture (SOA) backend technology stack having a plurality of services that are interconnected via various APIs, to enable various algorithms disclosed herein, any of which may be internal (e.g., for maintenance purposes) or external (e.g., for modularity purposes) to the computing instance. For example, some of such APIs may have, call, or instantiate representational state transfer (REST) or RESTful APIs integrations or some of services may have, instantiate, or call some data sources (e.g., databases, relational databases, database services, relational database services, graph databases, in-memory databases, RDS, S3, Kafka) to persist data, as needed, whether internal (e.g., for maintenance purposes) or external (e.g., for modularity purposes) to the computing instance, to enable various algorithms disclosed herein. For example, the computing instance may host or run an application program, which may be distributed, on the SOA hosting, deploying, calling, or accessing the services that are interconnected via the APIs, to enable various algorithms disclosed herein.

The computing instance may be in communication (e.g., wired, wireless, waveguide) with the computing terminal, the chatbot, or the LM over the network. For example, such communication may occur via the SOA backend technology stack, as explained above. The computing instance is separate and distinct from the computing terminal, the chatbot, or the LM. However, such configurations may vary. For example, the computing instance may internally host the chatbot or the LM.

The computing instance may be hosted within a data center. For example, the data center may be a building, a dedicated space within a building, or a group of buildings having a suitable computing infrastructure (e.g., an item of networking equipment) communicating (e.g., wired, wireless, waveguide) with the network and enabling the computing instance to operate, as disclosed herein.

The chatbot is exemplified as a computer program that simulates human conversation, allowing interaction through text or voice. The chatbot can handle various tasks, which may range from answering customer queries to providing support or automating processes. The chatbot can be a scripted or quick reply chatbot, a keyword recognition-based chatbot, a hybrid chatbot, a contextual chatbot, a voice chatbot, or another suitable chatbot form factor. For example, the chatbot may be OpenAI ChatGPT, Anthropic Claude, Google Gemini, Microsoft Copilot, Perplexity, or another suitable chatbot. The chatbot may be in communication (e.g., wired, wireless, waveguide) with the computing terminal, the computing instance, or the LM over the network. The chatbot is separate and distinct from the computing terminal, the computing instance, or the LM. However, such configurations may vary. For example, the chatbot may directly communicate with the LM or internally host the LM, to be operated thereby. Alternatively, the LM may directly communicate with the chatbot or internally host the chatbot, to enable the chatbot to be operated thereby. Additionally, the computing terminal or the computing instance may internally host the chatbot, whether the chatbot is separate and distinct from the LM or not, as explained above. Note that the chatbot is optional and may be omitted.

The LM may be exemplified as a language model (e.g., a generative artificial intelligence (AI) model, a generative adversarial network (GAN) model, a generative pre-trained transformer (GPT) model) including an artificial neural network (ANN) with a set of parameters (e.g., tens of weights, hundreds of weights, thousands of weights, millions of weights, billions of weights, trillions of weights), initially trained on a quantity of unlabeled content (e.g., text, unstructured text, descriptive text, imagery, sounds) using a self-supervised learning algorithm or a semi-supervised learning algorithm or an unsupervised learning algorithm to understand a set of corresponding data relationships. Then, the LM may be further trained by fine-tuning or refining the set of corresponding data relationships via a supervised learning algorithm or a reinforcement learning algorithm. For example, the LM may be trained using causal language modeling or autoregressive language modeling, which may enable the LM to employ a causal or an autoregressive approach to predict the next token in a sequence given a set of previous tokens. For example, the LM may be a unidirectional model, attending to context (e.g., tokens) before prediction. For example, the LM may be a GPT-3 model, a GPT-4 model, a PaLM-2 model, or another suitable LM. For example, the LM may be not a masked LM.

Once the LM is trained, the LM is structured to have a data structure and organized to have a data organization. As such, the data structure and the data organization collectively enable the LM to perform various algorithms disclosed herein. For example, the LM may be a general purpose model, which may excel at a range of tasks (e.g., generating a content for a user consumption) and may be prompted, i.e., programmed to receive a prompt (e.g. a request, a command, a query), to do something or accomplish a certain task. The LM may be embodied as or accessible via a ChatGPT AI chatbot, an Anthropic Claude chatbot, a Google Gemini AI chatbot, Microsoft Copilot AI chatbot, or another suitable LM. The LM may be prompted by the computing terminal or the computing instance, whether directly or indirectly. For example, the computing instance may be programmed to engage with the LM over the network, whether through the chatbot or without the chatbot, to perform various algorithms disclosed herein. Alternatively, the computing instance may internally host the LM and programmed to engage with the LM, to perform various algorithms disclosed herein. Such forms of engagement may include inputting a text (e.g., structured or unstructured) into the LM in a human-readable form, for the LM to output a content (e.g., a text, a structured text, an unstructured text, a descriptive text, an image, a sound), i.e., to do something or accomplish a certain task. Note that the LM can be scaled down into a small LM (SLM) or the SLM can be a miniaturized or less complex version of the LM, which can be trained on less data and fewer parameters than the LM. As such, various algorithms disclosed herein can use the SLM as the LM, as disclosed herein.

Based on the above, the computing terminal is operated by the data scientist such that the computing terminal runs the OS and the application program on the OS to communicate with the computing instance over the network, where the computing instance is hosted in the data center, which may also contain the chatbot or the LM. The chatbot or the LM may be controlled or operated by the data scientist from the computing terminal over the network through the computing instance. The computing instance performs the algorithms, as further described below. Note that these algorithms are examples and can be adapted as needed for various purposes.

To further understand this disclosure, various exemplifications are provided. A processing unit may be exemplified as a logical compute controller (e.g., physical) that executes a set of program instructions to perform various operations described herein, including, for example, generating a message in natural language, preparing and submitting an instruction to a language model, receiving a response, selecting a content that conforms to a format definition, issuing a pause command, persisting a checkpoint that stores a training state, modifying a hyperparameter of a running training process, restoring a checkpoint, issuing a resume command, and others disclosed herein. The processing unit may be exemplified as one or more general-purpose or special-purpose physical processors (e.g., a central processing unit, a graphics processing unit, a tensor processing unit, a digital signal processor, an application-specific integrated circuit, or a field-programmable gate array) operating alone or in combination, and may execute locally on a computing terminal or on a computing instance, or across a distributed arrangement thereof. In various implementations, the processing unit may be exemplified as a virtual machine, a containerized service, or a microservice that is hosted in a computing instance and communicates over a network with a language model and a running training process. An epoch boundary may be exemplified as a point in time when a completed pass through a plurality of training data samples finishes and before a next pass begins. A message in natural language may be exemplified as one or more sentences that describe metrics and observations in a human-readable language. A structured format may be exemplified as a machine-parsable encoding such as JSON, YAML, or XML. A control identifier may be exemplified as a hyperparameter name in a plurality of hyperparameters. An action type may be exemplified as set, add, subtract, or multiply. An action value may be exemplified as a numeric or categorical value constrained by a range or enumeration. A content may be exemplified as a portion of a LM response that includes a control identifier, an action type, and an action value. A block may be exemplified as a delimited set of fields in a structured format for a single control identifier. A window may be exemplified as a subset of epochs selected by count or percentage. An analysis duration may be exemplified as processor time measured from message generation start until content selection ends. A training state may be exemplified as data that includes a plurality of model weights and an optimizer state. A pause command may be exemplified as a control signal that halts weight updates at an epoch boundary. A resume command may be exemplified as a control signal that initiates a next completed pass through a plurality of training data samples. A checkpoint may be exemplified as a stored record that includes the training state comprising model weights and optimizer state. A format definition may be exemplified as a schema that specifies field names, types, ranges, and conformance rules for the structured format (e.g., a JSON Schema). A control output may be exemplified as a structured response from the language model that encodes a proposed change to a hyperparameter using the control identifier, the action type, and the action value. A recommendation may be exemplified as a language-model output that specifies a proposed change to a hyperparameter in natural language, structured form, or both. An approved list may be exemplified as a whitelist of adjustable hyperparameters in a running training process. A scale may be exemplified as a conversion context for a numeric action value (e.g., linear, logarithmic, percentage) used to compute a scaled value prior to applying the action. A mapping may be exemplified as a lookup from a control identifier to a hyperparameter name in a plurality of hyperparameters. A recent subset may be exemplified as a percentage of a sequence of epochs selected to emphasize a most recent portion of training.

Communication Architecture and System Integration: this disclosure enables a flexible communication architecture that enables seamless integration between machine learning training processes and language model components across diverse computing environments. In one embodiment, the system establishes communication through direct application programming interface (API) calls to cloud-based language model services, wherein training metrics are transmitted via standardized REST API protocols using JSON data formatting. The language model service receives the training metrics, processes them through its neural network architecture, and returns hyperparameter optimization recommendations through the same API channel, thereby enabling real-time optimization decisions during model training.

In an alternative embodiment, the system employs asynchronous message queue architectures to facilitate high-throughput communication between training processes and language models. Training metrics are published to message queues such as Apache Kafka, RabbitMQ, or cloud-native messaging services, while the language model component subscribes to these queues for continuous metric processing. This asynchronous approach enables the system to handle multiple concurrent training jobs and provides fault tolerance through message persistence and retry mechanisms.

In yet another embodiment, when the language model operates within the same computing environment as the training process, the system utilizes direct function calls or inter-process communication mechanisms. This local communication approach minimizes latency and enables immediate hyperparameter adjustments during training execution, particularly beneficial for time-sensitive optimization scenarios.

Language Model Architecture Independence: this disclosure enables operations with various language model architectures, thereby providing broad applicability and preventing design-around approaches. In one embodiment, the language model comprises transformer-based architectures including but not limited to Generative Pre-trained Transformer (GPT) variants, Bidirectional Encoder Representations from Transformers (BERT) family models, and Text-to-Text Transfer Transformer (T5) architectures. These transformer-based models leverage self-attention mechanisms to process training metrics and generate contextually appropriate hyperparameter recommendations.

In alternative embodiments, the system operates with recurrent neural network-based language models that utilize Long Short-Term Memory (LSTM) or Gated Recurrent Unit (GRU) architectures for sequential processing of training data. The system may also employ hybrid architectures that combine transformer and recurrent components, or ensemble approaches that utilize multiple language models for consensus-based optimization decisions.

Comprehensive Hyperparameter Optimization Scope: this disclosure enables optimization of diverse hyperparameter categories to ensure comprehensive training control. The system adjusts learning rate parameters including initial learning rates, learning rate schedules such as exponential decay, cosine annealing, and step-wise reduction, as well as adaptive learning rate algorithms. Batch size optimization includes determination of optimal batch sizes for training efficiency, mini-batch strategies for memory management, and dynamic batch size adjustment based on available computational resources.

Optimization algorithm selection and tuning encompasses various optimizers including Adam, Stochastic Gradient Descent (SGD), RMSprop, AdaGrad, and their variants, with parameter-specific tuning of momentum values, epsilon parameters, and weight decay coefficients. Regularization parameter optimization includes dropout rates, L1 and L2 regularization coefficients, and batch normalization parameters to prevent overfitting and improve model generalization.

Model architecture parameters subject to optimization include layer dimensions, activation function selection, network depth and width, attention head configurations in transformer models, and architectural hyperparameters specific to various neural network types including convolutional, recurrent, and transformer architectures.

Multi-Framework and Environment Integration: this disclosure enables seamless integration across multiple machine learning frameworks and deployment environments. Integration with PyTorch involves interfacing with PyTorch's training loop mechanisms, optimizer objects, and learning rate scheduler components. The system hooks into PyTorch's callback mechanisms and gradient computation processes to implement real-time hyperparameter modifications without interrupting training continuity.

TensorFlow integration utilizes TensorFlow's Keras API and custom training loops, interfacing with tf.keras.callbacks for metric monitoring and tf.keras.optimizers for parameter adjustment. The system integrates with TensorFlow's distributed training capabilities for multi-GPU and multi-node scenarios.

JAX integration leverages JAX's functional programming paradigm and just-in-time compilation features, interfacing with JAX's transformation functions and optimization libraries. Custom training loop integration provides flexibility for research environments and specialized training procedures that may not conform to standard framework patterns. The system operates across diverse deployment environments including local development machines, cloud computing platforms such as Amazon Web Services, Google Cloud Platform, and Microsoft Azure, edge computing devices with limited computational resources, and distributed computing clusters for large-scale training operations.

Advanced Operational Modes and Applications: this disclosure enables sophisticated operational modes for diverse machine learning applications. Real-time continuous optimization operates during active training sessions, with the language model continuously monitoring training metrics and providing immediate hyperparameter adjustments. This mode enables dynamic response to training dynamics and prevents suboptimal convergence patterns.

Multi-modal input processing capabilities enable the system to analyze both numerical training metrics and visual representations of training progress including loss curves, gradient histograms, weight distributions, and activation patterns. The language model processes these diverse input modalities to generate comprehensive optimization strategies that consider multiple aspects of training behavior.

Foundation model fine-tuning applications specifically address the optimization of Low-Rank Adaptation (LoRA) parameters, Quantized Low-Rank Adaptation (QLoRA) configurations, and adapter architectures. The system optimizes rank values, scaling factors, target modules for adaptation, and layer selection strategies for parameter-efficient fine-tuning approaches.

Federated learning coordination involves optimizing hyperparameters across distributed training nodes while maintaining privacy constraints. The system coordinates optimization decisions across multiple federated learning participants, adapts to varying computational capabilities and data distributions across federated environments, and maintains communication efficiency in bandwidth-constrained scenarios.

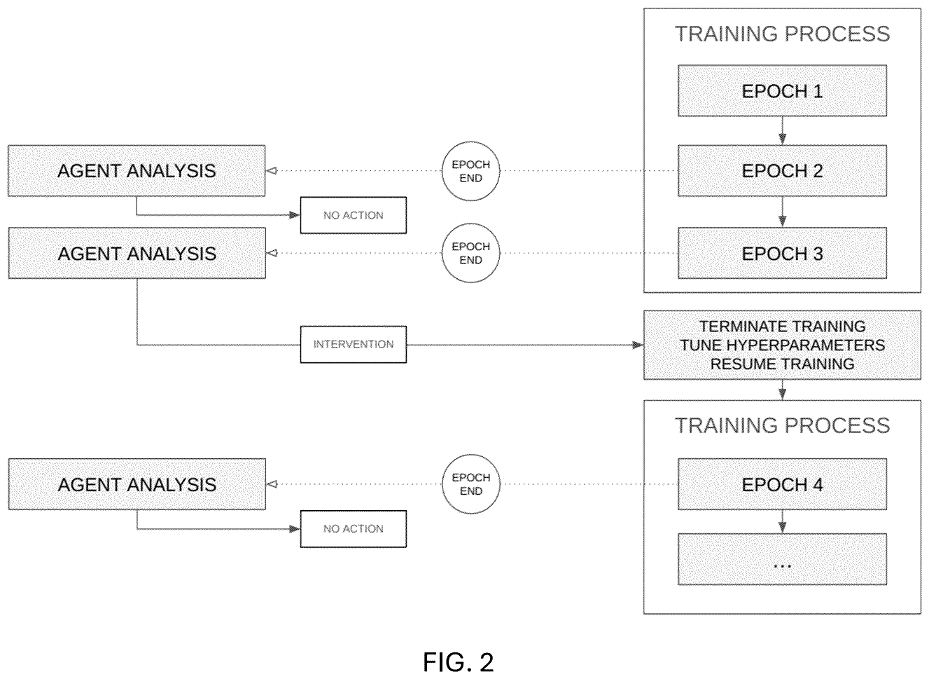

Starting the analysis: as shown in FIG. 2, we begin with a machine learning algorithm that has been training for some number of epochs that has been logging its training and validation relevant metrics to an accessible location. For the purposes of this discussion, we can assume that the machine learning algorithm is logging that data to a CSV (or another suitable structured data format such JSON or XML) file with a column for each recorded metric, at each epoch, alongside any other information relevant to the epoch. This log of relevant metrics then has a variety of analyses and transformations performed thereon. The purpose of the transformation is to put the training and validation relevant metrics into a format that will be consumed by an LM agent further described in the Linguistic Context section. The level of analysis varies from directly lifting (e.g., copying) values from the raw data as-is to secondary machine learning analysis of the performance data, such as linear regression. The exact analyses involved can be adapted as needed and the analyses may vary from model to model or even a single model training session. For instance, the analysis may include an analysis of just the most recent 25% epochs of training once at least some minimum number of epochs (e.g. 3, 10, 15) has been reached. This sort of analysis transformation would be helpful to avoiding early epochs giving an impression of continued fitting even after the model has converged into a local minima in later epochs. Note that the processing unit may compute a trend over selected performance metrics by linear regression and appends a description of the trend to the message in natural language.

This analysis and subsequent actions (as described later, in the Applying Changes to the Model section) should be executed on a separate process from the model training process (although this analysis or subsequent actions can be included in the model training process). This configuration may be motivated by several considerations, none of which are required or necessary. First, these analyses can be computationally intensive. Sometimes, we may want to avoid unnecessarily slowing down the neural network training process. Adding additional processing time would contradict the goal of accelerating training times. Second, separating the analysis from the training process mitigates the risk of uncaught errors in the analysis tools or LLM agent crashing the training session. If the analysis fails, then the training process should remain unaffected. Third, our preferred approach for updating hyperparameters involves terminating the current training process and resuming the training session with the modified hyperparameters. Although it's technically possible to combine this entire system in a single process, doing so introduces unnecessary risks, which may be sometimes not acceptable or desired. Nevertheless, such an implementation is possible.

Linguistic Context: once these data analyses and transformations have been performed, these data analyses and transformations need to be placed into the proper linguistic context for the LM to analyze. First, we compose a system prompt for the LM. This prompt serves as a foundation for the task at hand, offering broad context and essential reminders on machine learning principles. For example, the prompt may start, “You are an advanced AI system that monitors and adjusts neural network training sessions.” The system prompt includes helpful hints and guidance on basic analysis techniques, such as understanding the implications of coefficient values in linear regression models and recognizing signs of overfitting or underfitting. For example, the prompt may include “Remember that a negative coefficient for val_loss implies that a model is learning, while positive implies it is not learning.” Furthermore, this initial prompt primes the LM to generate answers in a format that is compatible with the rest of the system. Now that the LM has been primed with a system message, we now compose a longer ‘human’ message that contains all the transformed data in the proper linguistic context as described below. This human message includes specific information both pulled directly or computed from the model performance data, such as its recent losses and validation metrics. For example, let's say that the difference between the most recent loss and validation loss values is small, say 0.03, then we may transform the validation loss to loss differential of 0.3 into a sentence such as: “In the most recent epoch, val_loss was slightly higher than loss by 0.03.” We can also add helpful hints or explanations to provide more context, such as: “As val_loss is higher than loss, this could be a sign of overfitting.” We have also found that adding these sorts of hints and explanations reduces instances of hallucination by the LM agent. The exact sentences and explanations used in these messages are dynamic and flexible. If the value is larger, say 1.39, then we might generate a different sentence, such as: “val_loss is significantly higher than loss, this model is likely significantly overfit”. This new sentence suggests that the model may be overfitting more severely. The way we generate these messages depends on specific thresholds or percentage-based measures. For instance, if the validation loss is more than some absolute or percentage threshold, then depending on how this algorithm is implemented, it's likely a strong indication of overfitting. Some readers may wonder why the LM is not bypassed at this point, given that the large difference in loss values alone seems sufficient to assess overfitting. However, consider a scenario where the significant gap between loss and validation loss has been persistent throughout training, and both metrics are decreasing at a significant rate, then one would likely prefer to let their model continue training. As such, the ability of this algorithm to take multiple seemingly contradictory data points about training and to reconcile this into an intelligent action further improves computer functionality, as mentioned above. Many LMs are trained in a ‘chat’ format where they are given a system prompt explaining the context of the chat, and then a series of messages by a human (data scientist). We have found that co-opting this training by presenting our transformed data as a human asking a question of the LM provides an optimal performance on this task in some situations. Our testing has shown this to be an effective way to utilize the algorithm disclosed herein. However, other methods can also be used to present the same data to the LM, such as text completion. These other approaches should still be covered by this disclosure. Using the chat format within this algorithm serves two purposes: it illustrates an effective way of utilizing this algorithm, and it helps clarify how the algorithm works (easier to conceptualize this interaction in the lens of a standard human/LM chat than by using a more esoteric yet broadly applicable mode of operation like text completion).

LLM Recommendations: now that we have collated all pertinent information into a system message and a ‘human’ message, we can run the LM. There are at least two ways of receiving the analysis from the LM. Firstly, one could have the LM provide a simple analysis of the training session with a predefined word such as “FIT”, “OVERFIT”, “UNDERFIT”. Once you have this basic analysis, you could prepare a basic intervention using known techniques for addressing it. For instance, with overfitting one might increase the setting of dropout on various layers in the neural network. Secondly, a more advanced and flexible approach is to have the LM suggest specific interventions instead of just determining fitting, overfitting, underfitting. One such way of doing this would be to have the LM prepare a JavaScript Object Notation (JSON) or similar format (e.g., XML) of metaparameters and adjustments. Continuing the previous example, the LM might suggest something like the following:

```
{
  “dropout”: “0.05”,
  “learning_rate”: “1.1”
}
```

At this point, we should address how the suggestion of the LM agent is transformed into a change in the hyperparameters of the neural network. Using the example above, we could interpret that action in different ways. For example, we could see the adjustments as multiplicative changes to the current values. So if we had a starting value of 0.5 for dropout and 0.01 for learning_rate, our new values would be 0.025 for dropout and 0.011 for learning_rate. Alternatively, we could see the adjustments as substitution changes to the current values. In this case, dropout would now be 0.05 and learning_rate would now be 1.1. We could also envision more advanced suggestions. We will keep to JSON for simplicity and readability, but suitable other data formats (e.g., XML) would also work here.

```
{
  “dropout”: {
    “action”: “multiply”,
    “value”: “0.05”
  },
  “learning_rate”: {
    “action”: “set”,
    “value”: “0.084”
  }
}
```

The output from the LM using this more advanced method is more explicit, enabling the system to both modify and overwrite hyperparameters based on its suggestions. In a more advanced system, additional information may need to be passed to the LM, although this is not required. This information may include hints about the current values of metaparameters, suggestions of how changing the values might affect the training session, a history of previous changes the agent has made to this current training session and their corresponding results, or others.

Response Malformations and Invalid Actions: with these progressively more intricate outputs from the LM agent, the possibility of errors and formatting malformations in the provided response increase dramatically. Suppose that the agent provided the following response:

```
{
  “dropout”: {
    “action”: “multiply”,
    “value”: “0.05”
  }
  “learning_rate”: {
    “action”: “set”,
    “value”: “0.084”
  }
}
```

While the message may appear identical to the previous one, we've introduced a critical difference: the absence of a comma between the end of the dropout and learning_rate blocks. A basic parser would typically throw an error here. While the message may be clear to humans, code like this may fail or produce incorrect results. There are many ways to attempt and fix any malformations like this. However, there are two approaches, which can be combined, that are interesting enough to merit mention here.

Approach 1: Extracting Valid Actions: if you catch an error in parsing the message, then don't fail completely. Go through with dedicated scanning code that searches for correctly formed blocks within a corrupted message, and extract valid actions. Looking for known keywords like “dropout” would allow you to find the area in the message that contains important actions and attempt to recover them individually. Even if you end up with invalid commands, you can still attempt to perform a partial intervention with the valid ones you were able to extract. In many cases, this will be better than taking no action at all due to a malformed message. For example, if the agent was attempting to tell you to both decrease dropout and increase learning rate, then the agent will likely give you better results when you just decrease dropout compared to taking no action at all due to a malformed message. This also applies to invalid commands within a validly formed message. Consider the following action:

```
{
  “dropout”: {
    “action”: “multiply”,
    “value”: “0.05”
  }
  “I5_normalization”: {
    “action”: “add”,
    “value”: “0.1”
  }
}
```

The normalization “15_normalization” is invalid. It's a hallucination. Although the underlying code does not have the ability to modify a non-existent normalization, we can and should do other requested actions like adjusting dropout and learning rate to the best of our ability. This is one of the ways in which we can mitigate LM hallucinations after they have occurred. While it is important to do everything possible to minimize the risk of hallucinations occurring, there are still corrective measures that you can take.

Approach 2: Error Correction: feed in the malformed and/or invalid message along with whatever error occurred in trying to process the message, with instructions to the LM to provide a new message that fixes these errors. This approach can be an iterative process, so that if there are multiple malformations or invalid commands within the message, then these commands can be resolved in sequence, with each new error being re-sent into the correction LM. This loop continues until the message no longer contains any malformations or invalid commands, we encounter the same error repeatedly thereby indicating that the LM is stuck and unable to correct the message, or a maximum number of attempts is reached, after which we stop trying to correct the message. Note that using the same LM as before also opens the possibility of adjusting the intervention strategy if previous assumptions were incorrect. If the agent was trying to increase dropout to combat severe overfitting, but the adjustment would have led to a dropout over the maximum amount of 1.0, then the agent now has the potential to adjust other hyperparameters to account for this shortfall. This iterative back and forth approach also has the potential to be used outside of error correction. Rather than just supplying all pertinent information in a single human message, the iterative back and forth approach can allow for a conversation between the LM agent and the analysis tools. If the agent is unsure about a classification or action, then the agent could request additional information from the tools, such as detailed analyses like a linear regression on specific subsets of loss curves, insights into other metrics like precision and recall beyond the standard set of analyses, current values of hyperparameters, even those outside its normal ability to tweak, like number of layers and neurons per layer, or others. While more complex, this communication shares the principles of our basic case. For this sort of conversation between agents and tools we recommend using langchain, which is an open source library that simplifies these interactions. However, using langchain is not required and other suitable libraries can be used.

To bound interaction per epoch boundary, the analysis tool enforces a maximum count of structured responses from the language model for a given epoch boundary. After the maximum is reached, no further responses are accepted for that epoch boundary.

Applying Changes to the Model: at this point, we have a valid collection of changes to the hyperparameters that we need to implement within the model. Notably, this could be an empty collection, due to either the agent not recommending any changes to the underlying model, or if we were fully unable to parse the recommended changes. In fact, not having any changes can be the default behavior in some embodiments. When the model is training effectively, there's no need for intervention in some embodiments. In such cases, the analysis process can be stopped until called upon again to perform another analysis. When we do have actions that we want to take, these changes to the underlying model can be implemented in various ways, i.e., there are many different ways to accomplish this that all have the same end result-a model that is the same as the one currently running, except in regards to the changed hyperparameters.

ACTION TYPE SEMANTICS: A multiply action is applied only to numeric hyperparameters and computed as new=old×value; a set action is applied to categorical hyperparameters by substitution. Bounds are enforced prior to application.

STATE-SAFE UPDATE POINTS: In real-time updates without pausing, the processing unit applies modifications at a minibatch boundary and refreshes scheduler-derived parameters (e.g., learning rate) so that gradient statistics and mixed-precision scalers remain valid.

LAYER-ADD WITH PERSISTENCE: When adding a layer, the processing unit re-initializes parameters of the added layer, retains prior layer tensors, and re-creates optimizer state for the new parameters while preserving existing moments for unchanged tensors; incompatible slots are re-initialized.

For illustrative purposes, this algorithm was implemented as part of an advanced MLOps platform that offers a model format designed specifically to make these kinds of changes easy. The format used is cross-compatible with other formats, allowing seamless translation between them (e.g., Tensorflow). Important parameters like dropout on a specific subset of Long Short-Term Memory (LSTM) layers might appear, for example, like this:

```
{
  “name”: “lstm”,
  parameters: [
    {
      “name”: “layers”,
      “value”: 3
    },
    {
      “name”: “neurons”,
      “value”: 30
    },
    {
      “name”: “dropout”,
      “value”: 0.3
    }
  ]
}
```

In this system, if we were to modify the model definition by changing the dropout value from 0.3 to 0.5, then we could then rebuild the model while preserving all other settings intact. If we then loaded our saved weights/optimizer settings/etc., then we would then have an exact copy of the model as it was training, with the exception of the updated value for dropout. While not a requirement for implementing these changes or for this algorithm as a whole, the optional model format provided by this MLOps platform simplifies the process and makes it easier to visualize. If one were to take the single process approach (as discussed earlier in the Starting the Analysis section), this method wouldn't work in some use cases. One would instead want to use a custom training loop, interrupt the loop with this algorithm, iterate through the entire model object in memory, make any changes, and (depending on the specific changes) possibly start another training loop to ensure that the changes can take effect.

In one version of this algorithm (e.g., an optimal version), we now have a model with all the desired changes implemented, along with the current values of the weights and other parameters that would be expected to be in place at this point in training. We now terminate our training process.

Timing Edge Case: as it has been running independently up to this point, there is a potential edge case where our training epoch time is less than the time required for analysis. If this occurs, then you can apply the changes to the most recent epoch, even though a new analysis might suggest different actions; terminate the training session and perform a new analysis on the most recent epoch, or ignore the latest epoch and just apply your changes to the one in which you performed the analysis. There are valid arguments to all three of these approaches, and one can either be selected as the default behavior, or the decision could be given to the user who initiated the training session. We've found the first strategy to be generally reliable in some use cases. Interventions suggested by the agent are usually relevant for multiple future epochs, not just for the epoch immediately following the current one. The potential downside, i.e. “what if there was a different recommended action for the next epoch?”, is often recognized and mitigated by the agent in later epochs. To prevent this problem altogether, one could incorporate timings into the analysis tool. This would allow you to limit additional analysis and error correction when approaching a certain percentage of the time elapsed between epochs, effectively mitigating the risk of this edge case occurring.

Continuing Training: with the original training process terminated, we initiate a new training process. This new process loads up the corrected model definition, along with the weights and other relevant parameters from the most recent epoch of training. By doing so, we have successfully applied all of the changes suggested by the model to our current training run. This process can be repeated at the end of each subsequent epoch. From a training perspective, this is still the same model that was training earlier, but now we have new settings for certain hyperparameters, which will enable us to better adapt to the evolving needs of the current training run.

In one implementation, the LM is a transformer-based model configured with a whitelist of adjustable hyperparameters (e.g., learning rate, batch size, dropout), an action retry limit of three correction attempts for malformed outputs, state-safe update points at minibatch boundaries, and a default timing policy that limits analysis to at most 30% of the prior epoch duration. These settings were found to reduce wasted compute while maintaining training stability in deep learning workflows.

Advanced Topics: although we've covered the fundamental aspects of the algorithm, there are some more complex topics that warrant attention. Delving into these advanced concepts now, rather than earlier, will minimize or prevent confusion and ensure a deeper understanding of how the algorithm functions.

Hallucinations: LMs are susceptible to a critical issue known as hallucinations, wherein they generate text that seems reasonable, but is not based in reality. This can manifest in various ways, such as when an LM mistakenly describes a potential future event instead of accurately stating its non-occurrence. For instance, when asked about the 67th US presidential election, a poorly managed LM might actually write out a description of a potential future election, rather than correctly noting that such an election has yet to occur. When analyzing training results, the problem of hallucinations is even more insidious. The evaluation of overfitting and underfitting can be subjective and vary between experts. This ambiguity creates an opportunity for LMs to generate misleading interpretations of a training session that go undetected. To minimize the occurrence of hallucinations, it is essential to perform extensive testing of the agent's analysis during the development phase. Identifying common sources of hallucinations and incorporating specific reminders into prompts can help prevent these issues. Furthermore, one can be proactive by adding reminder text to the messages sent to the agent with how to properly analyze the given data. When analyzing individual data points with a training session, it is often possible to determine whether they imply overfitting, fitting, underfitting, or if it is inconclusive on its own. By providing the model with hints about what these analyses suggest and how strongly they imply certain outcomes, you can minimize the potential for hallucination and enable the model to focus on generating actionable insights.

Limiting Analysis by Epoch: up to this point, we are assuming that this process is being run after every single epoch of training. However, certain powerful analyses might not be relevant if run on every single epoch. For instance, curve analysis isn't feasible after just one epoch, as one point doesn't make a curve. While you could still analyze the difference between the training and validation metrics, this would yield a significantly less powerful analysis. We have found it technologically advantageous to wait at least 2-3 epochs before running the first analysis pass on the training, although this configuration is not required. Two epochs allows you to measure the direction of the trend for any relevant metric. Three epochs allows you to see variance from that trend, and allows for a bit more certainty on how strong of a trend you are looking at. By waiting for a minimum number of epochs before initiating analysis, we can avoid unnecessary and/or unhelpful interventions. This approach can be implemented either through the training process's callback process or by modifying the analysis code to exit early and skip unnecessary calculations. You might also want to consider waiting for some minimum number of epochs after an intervention has been performed before performing another analysis. With tools like linear regression in a long running training session, a successful intervention may be hard or impossible to identify with one extra epoch. Instead, an analysis of the epochs since the last intervention would only show you what effect that specific intervention has had, which can then be contrasted against previous training behavior to determine if more intervention is necessary. The usage of other analysis tools, such as moving averages and filters designed to eliminate old signals, can also help address this issue.

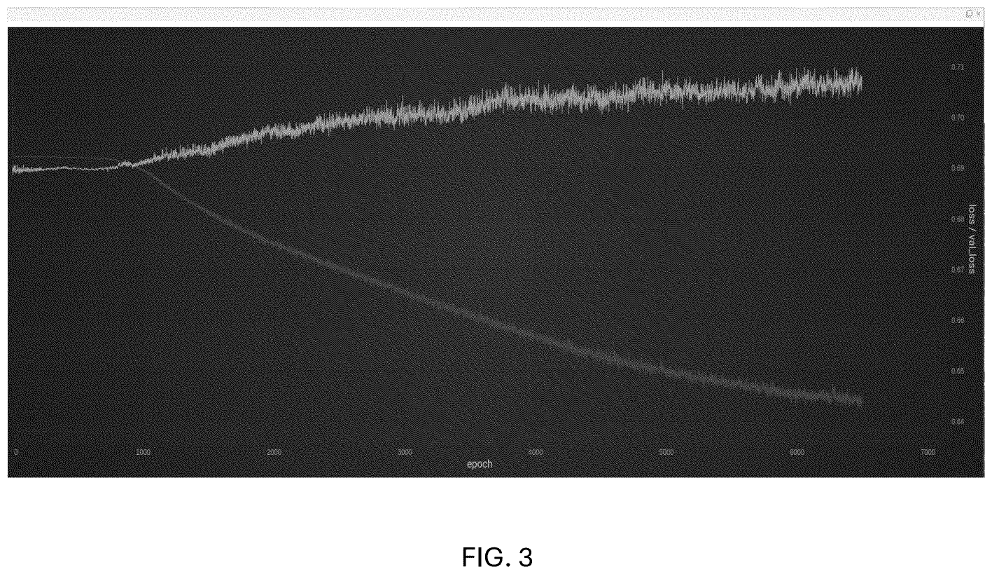

Rewinding to Previous Epochs: As shown in FIG. 3, since we are saving the training state at each epoch, we also have the ability to “rewind” to a previous epoch. Sometimes when training machine learning algorithms, like in the example below, one can spot a point on a loss curve where the model transitions from “fit” to “overfit”. This can be a divergence between the loss and val_loss values, a massive spike in val_loss, or many other things.

If the agent identifies an epoch where the model starts to overfit or deteriorate, then we can provide the capability for the agent to revert back to the previous epoch and take more drastic measures to prevent this from happening. This approach not only allows for the recovery of an otherwise completed training session, but also enables the agent to explore more experimental approaches on a regular basis. With the knowledge that we can undo a bad intervention, we can “rewind time” and try alternative strategies instead. As far as implementation goes, this is surprisingly straightforward, as all of the necessary tools for analysis, restoration, and model modification are all already present, we just need to put some basic safeguards in place to check that the agent doesn't get stuck in a loop constantly restoring to the same point if nothing can be done to fix it. In one embodiment, the system records, for each checkpoint, a restore count that is incremented on each restoration and compares the restore count to a threshold. When the threshold is exceeded, the system prevents further restoration to that checkpoint.

Adjusting Unusual Hyperparameters: since we are already stopping and restarting training sessions, it is possible to adjust parts of the model that are normally locked during active training. Let's consider an example where a model is underfitting due to lack of neural complexity. No amount of lowering dropout or tweaking learning rate or batch size will make this model properly fit, although some amount may be possible in some use cases. Rather than assuming the model is destined for failure due to its initial complexity limitations, we can take proactive steps to enhance its capabilities. To achieve this, we freeze the pretrained upstream layers and add new layers beneath them. We then train these additional layers for a specified period, allowing the model to adapt and improve before unfreezing the rest of the model and letting it continue to train. With our earlier model format in mind, we can simply mark the existing layers as non-trainable by setting “is_trainable” to “False”. Next, we add connections between these frozen layers and the new ones that will be trained. Finally, we spin up a new training session. We're fortunate that all the necessary tools for implementing these enhancements are already integrated into our system. To take full advantage of them, we simply need to grant the agent control over adding additional layers and deciding when to unfreeze the entire model. With this configuration, the agent can exercise its decision-making capabilities to determine the optimal time to add new layers or unfreeze the entire model. This flexibility allows us to explore various freeze-thaw strategies that suit our specific needs. Giving the agent free reign over adding additional layers introduces other potential risks, such as the new model becoming too large to fit on a Graphics Processing Unit (GPU) where it previously ran smoothly. To mitigate these risks, we must prioritize proper error handling and resilience. This includes implementing processes that allow us to revert changes if the training session crashes or encounters other issues. In fact, addressing these concerns can be done via user control.

User Control: as one can see, many aspects of this algorithm are highly tunable, allowing users to fine-tune settings to suit specific problem domains. To facilitate this, it is recommended that a user control panel be provided as a front end application that allows these settings to be tuned on a run by run basis, although this configuration is not required. One technical benefit of this approach is the ability to dynamically turn the algorithm on or off during an active training session. Furthermore, the user could use this dashboard to issue their own interventions outside of the algorithm. If a user notices overfitting before the agent does, then the user can use the control panel to issue their own set of actions to apply to the model. The training process can then seamlessly pick up these human interventions, effectively incorporating the user's intervention in lieu of its own analysis and intervention. We could also change our prompting of the agent in regards to how aggressively and/or frequently it intervenes. By changing the system prompt, we can add lines like “Bias towards frequent interventions”, “Try to make small changes to any hyperparameter”, “Focus your interventions to fix any overfitting, only intervene in underfitting in the most extreme cases”, and “Focus your efforts on raising the val_precision metric, even if doing so causes overfitting or underfitting in other areas”. To make this work, we simply need to format user interventions in a manner consistent with the agent's. This enables seamless collaboration between humans and agents.

In some embodiments, the algorithm may include replicating the various analysis tools that we run model training results through before the results of said tools are sent into the LM. One could then take all of these analyses and then use an alternative to an LM in order to process this data. After this alternative provides its recommendation or classification, one could merge back into the algorithm to change the hyperparameters of the training model. This would allow you to keep the rest of the portions of the algorithm while still doing a fundamentally different approach.

As shown in FIG. 2, after epoch 3, an intervention is requested by the agent which causes the current process to be terminated, changes to be made to the model, and a new process initiated, continuing the training in a new process with the requested changes. Starting a new operating-system process continues the same training run by restoring the checkpoint; the machine learning model is maintained without reinitialization of learned weights

One alternative to an LM may be an expert system (e.g., a rules-based engine) with a series of if/else statements breaking down things like the direction of the loss/val_loss curves, gap between loss/val_loss values, and epochs since the lowest loss/val_loss value in order to select from a predefined list of actions to address the categorized behavior. This approach would be significantly more time consuming, while also losing a considerable amount of flexibility afforded by the LM.

One alternative to an LM may be taking these analyses and turning them into features that can be fed into a non-LM neural network or other machine learning algorithm which can be trained to either classify behavior or to suggest specific interventions. This approach also has its shortcomings, including a need to gather training data, and possibly to label it depending on the specific machine learning algorithm used. It is possible that with sufficient training and time this approach could even exceed the performance described above in some situations, although that is not a given and the costs associated with this approach would currently be substantial, although feasible if desired.

Another approach would be to use a standalone multimodal LM. This LM could be provided with an image of the relevant training graphs for a neural network alongside a prompt describing the problem at hand, having it return some useful information about the training session. Then, a human could perform an intervention by hand. However, the human would not be able to automatically adjust the hyperparameters of an actively training neural network unless the algorithm is practiced. Displaying a loss curve as an image and then using the rest of this algorithm as is instead of as the results of a linear regression or directly outputting the values of said curve should not be viewed as being sufficiently different from this algorithm, as adding that as an additional analysis would be trivial in our current implementation, and we don't do so simply because it would be time consuming both to implement and on a per-usage basis while likely providing negligible additional performance on improving the training session.

Another approach would be to implement their own user control panel as described above, without the LM based agent. This would allow them to manually monitor their training session as the LM would, and make their own judgment calls for what to do. This obviously has the downside of requiring constant supervision by a human who has the skill-set to analyze and intervene in these runs.

There are some existing methods to solve this problem that could be used in some use cases. The concept of a hyperparameter search is known within the field of machine learning, and there are multiple approaches one could undertake to address this problem. All of the currently known approaches however are static in regards to the actual training of the neural network—these hyperparameters are set at the start of training, and are rarely touched after the training session has begun. Things like learning rate schedulers can allow for some hyperparameters to be changed during training with various degrees of intelligence and complexity. However, all these existing approaches are far less intelligent and complex than the algorithm disclosed herein, and none have the knowledge of actually plugging into an AI system, let alone an LM.

The algorithm disclosed herein has the potential to be technologically advantageous in any deep learning task. Some software libraries that may be used to implement this algorithm include Python, Keras, Tensorflow, Pandas, Langchain, Llama3, Ollama, Scikit-learn, Pydantic, HDF5/H5PY, CUDA, or cuDNN. As such, the algorithm disclosed herein could be used with any LM, such as any LLM, as its decision making piece, with the knowledge that its overall efficacy can vary depending on the quality of the underlying LM, and that if a different LM would be substituted, then a fine tuning pass on the prompts would likely be advantageous to improve the performance of the algorithm. To further improve the algorithm disclosed herein, one may deploy a custom trained LM fine-tuned for this specific problem. Therefore, the algorithm disclosed herein enables an autonomous adjustment algorithm that performs hyperparameter optimization within an active training session, with minimal or no human oversight. This technology improves computer functionality by utilizing the LM within the training session itself, doing analysis, optimizing hyperparameters, and designing interventions constantly (every epoch) within or during each training session. Note that some embodiments of the algorithm have the potential to cause interference in some more traditional hyperparameter searches when used in combination. Hyperparameter searches are already known to be difficult due to the astronomical number of possible permutations, and our approach increases the possible search space by an enormous margin. Whereas before, something like dropout can only exist in a spectrum between 0 and 1, this algorithm allows dropout values to vary and change within the run itself. Instead of just being able to cut up dropout values by say every 0.01 value (for 100 possible values to test), we now have numerous other patterns of dropout within the training session itself to consider. If we consider a training session with a maximum of 100 training epochs, then every possible combination of dropout values across all 100 epochs is a significantly higher number of 100¹⁰⁰ possibilities. This unprecedented explosion in the available search space should be considered when choosing a hyperparameter search method to use in concert with this algorithm in some use cases. While the other methods of hyperparameter searching aren't currently able to directly interface with this additional search space, this algorithm can. If we want to exhaustively search a single set of starting hyperparameters with this algorithm, then we have access to things like freezing/adding/unfreezing additional layers and neurons, rewinding to epochs prior to loss/val_loss divergence, and controls on how aggressively/frequently the agent intervenes to name just a few possible search areas—each of which represents an enormous search space. As we discuss in our user control section, control over this search space can be partially surrendered to an outside actor. This outside actor could even be a hyperparameter search algorithm if it was properly instrumented.

As described above, the field of machine learning hyperparameter optimization has evolved through several distinct approaches, each with significant limitations that this disclosure addresses through novel language model integration. Traditional Automated Machine Learning (AutoML) platforms, such as Google AutoML, H2O.ai, Auto-sklearn, and similar systems employ predetermined algorithmic approaches for hyperparameter optimization. These systems rely on fixed mathematical optimization techniques, typically utilizing grid search, random search, or evolutionary algorithms to explore hyperparameter spaces. Such approaches operate without contextual understanding of the training dynamics and cannot adapt their optimization strategy based on real-time training behavior.

Critically, existing AutoML platforms lack the ability to interpret training metrics in a human-like manner or provide reasoning for their optimization decisions. They follow rigid optimization protocols that cannot adjust to unexpected training scenarios or leverage domain knowledge that would be apparent to human practitioners. This disclosure overcomes these limitations by employing language models capable of natural language reasoning, contextual understanding, and adaptive strategy modification based on observed training patterns.

Bayesian Optimization and Mathematical Approaches: prior Bayesian optimization methods for hyperparameter tuning, including approaches using Gaussian processes, Tree-structured Parzen Estimators (TPE), and Sequential Model-Based Optimization (SMBO), rely on mathematical models to predict optimal hyperparameter configurations. While these methods can be effective for certain optimization landscapes, they suffer from several fundamental limitations that this disclosure addresses.

Bayesian optimization approaches require substantial computational overhead for model updating and acquisition function evaluation, making them impractical for real-time optimization during training. They operate on mathematical abstractions of the optimization landscape rather than contextual understanding of training dynamics. Most significantly, these methods cannot incorporate the type of nuanced reasoning that human experts apply when observing training behavior, such as recognizing overfitting patterns, identifying gradient explosion symptoms, or understanding the implications of specific loss curve characteristics.

As described above, the disclosed technology leverages language models' ability to process and reason about training metrics in a manner analogous to expert human judgment, while maintaining computational efficiency for real-time operation.

Static Learning Rate Schedulers and Predetermined Strategies: existing learning rate scheduling approaches implement predetermined mathematical functions for hyperparameter adjustment, including exponential decay, cosine annealing, step decay, and polynomial decay schedules. These methods follow fixed mathematical formulas regardless of actual training progress, lacking the ability to adapt to unexpected training dynamics or model-specific requirements.

As described above, static schedulers cannot respond to early convergence, unexpected loss plateaus, gradient explosion events, or other training phenomena that would prompt experienced practitioners to modify their approach. This disclosure enables dynamic, contextual adjustment capabilities that can recognize and respond to such training events through language model reasoning.

Grid Search and Random Search Limitations: traditional grid search and random search methods for hyperparameter optimization represent brute-force approaches that lack intelligence or adaptability. These methods systematically or randomly sample hyperparameter combinations without learning from previous results or adapting their search strategy based on observed outcomes. As described above, such approaches are computationally expensive, often requiring extensive training runs to evaluate each hyperparameter combination. They cannot leverage insights from partial training results to guide future optimization decisions, nor can they provide explanations for why particular hyperparameter configurations might be beneficial for specific training scenarios.

Classical Early Stopping and Monitoring Systems: existing early stopping mechanisms and training monitoring systems operate on simple threshold-based rules or basic statistical criteria. These systems can detect convergence or divergence but lack the sophisticated reasoning capabilities to determine optimal intervention strategies or to provide actionable recommendations for training improvement. Classical monitoring approaches cannot interpret complex training patterns or provide the type of nuanced adjustments that this disclosure enables through language model integration.

Language Model-Based Hyperparameter Search Systems: recent research has explored using language models for hyperparameter optimization in pre-training search scenarios. For example, Zhang et al. (2023) propose “Using Large Language Models for Hyperparameter Optimization” (arXiv:2312.04528), which is incorporated by reference herein for all purposes and employs language models to suggest hyperparameter configurations through an iterative search process. In Zhang's approach, a language model receives descriptions of datasets and model architectures, suggests complete hyperparameter configurations, waits for entire training runs to complete, evaluates final performance metrics, and then suggests alternative configurations for subsequent separate training runs. This iterative approach operates across multiple distinct training sessions, with each session executing from initialization to completion using static hyperparameter values throughout its duration.

While this Zhang paper demonstrates that language models possess reasoning capabilities relevant to hyperparameter selection, the approach fundamentally differs from this disclosure in several critical aspects. First, this Zhang paper operates as a meta-level search algorithm that treats each training session as an atomic evaluation unit, requiring complete training runs to assess hyperparameter quality. The language model in such systems receives only final outcome metrics after training completion and cannot observe or respond to intermediate training dynamics. Second, in Zhang paper, hyperparameters remain static throughout each individual training session, with modifications occurring only between separate training runs. This approach inherits the computational expense and time requirements of traditional hyperparameter search methods, as it must execute numerous complete training sessions to explore the hyperparameter space. Third, this approach cannot leverage training state preservation, as each suggested configuration requires starting a new training session from randomly initialized weights rather than continuing from a saved training state.

This disclosure fundamentally differs from this Zhang paper by performing hyperparameter optimization within a single continuous training session rather than across multiple separate training runs. As described above, the language model continuously monitors training dynamics during active training execution, analyzes intermediate training metrics at epoch boundaries or other checkpoints, identifies training phenomena, such as overfitting, underfitting, or convergence issues as they emerge, and provides immediate hyperparameter adjustments that are applied without terminating the training session. The system preserves training state including model weights and optimizer state, enabling seamless continuation of training under modified hyperparameters without requiring reinitialization. This real-time adaptive approach provides fundamentally different capabilities compared to iterative search systems, including the ability to respond to transient training phenomena that would not be apparent in final outcome metrics, continuous adaptation to evolving training dynamics rather than fixed configuration selection, and elimination of computational waste from running multiple complete training sessions. Therefore, while this Zhang paper demonstrates language model reasoning about hyperparameters in a search context, it does not disclose or suggest the real-time, within-training-session optimization approach disclosure herein.

Additional Language Model-Based Hyperparameter Search Research: subsequent research by Liu et al. (2024) in “Large Language Model Agent for Hyper-Parameter Optimization” (arXiv:2402.01881), which is incorporated by reference herein for all purposes, presents a similar approach designated as AgentHPO. This system employs two specialized agents: a Creator agent that generates and refines hyperparameter configurations based on task descriptions provided in natural language, and an Executor agent that conducts experiments and analyzes results. The approach operates through an iterative optimization loop where the Creator agent suggests complete hyperparameter configurations, the Executor agent executes full training runs from initialization to completion using these static configurations, performance metrics from completed training runs are evaluated, and the Creator agent suggests alternative configurations for subsequent separate training sessions. Like Zhang paper mentioned above, this approach treats each training session as a discrete evaluation unit, with hyperparameters remaining fixed throughout the duration of each individual training run.

The AgentHPO approach fundamentally operates as a meta-optimization framework across multiple distinct training sessions, similar to traditional hyperparameter search methods but utilizing language model reasoning to guide the search process. The system demonstrates improvements in trial efficiency compared to random search and achieves competitive performance with human expert configurations. However, the approach shares the same fundamental limitations as the Zhang paper relative to this disclosure. Specifically, AgentHPO requires complete training runs for each evaluated configuration, cannot respond to intermediate training dynamics as they occur, operates with static hyperparameters throughout each training session, and must restart training from random initialization for each new configuration rather than preserving and continuing from existing training state.

This disclosure provides fundamentally different capabilities through real-time, within-session optimization that continuously monitors training progress during a single training session, responds immediately to emerging training phenomena without waiting for training completion, modifies hyperparameters dynamically at epoch boundaries while preserving model weights and optimizer state, and eliminates the computational expense of executing multiple complete training runs. The AgentHPO approach, while demonstrating that language models can reason about hyperparameter selection, does not disclose or suggest the continuous, state-preserving, within-training-session optimization methodology.

This disclosure has various technological advantages relative to conventional techniques:
Natural Language Reasoning and Contextual Understanding: Unlike mathematical optimization approaches, this disclosure employs language models capable of interpreting training metrics within broader contextual frameworks, analogous to expert human reasoning.
Real-Time Adaptive Decision Making: this disclosure enables immediate optimization responses during training execution, contrasting with offline optimization approaches that require separate training runs for evaluation.
Human-Interpretable Explanations: the language model component generates natural language explanations for optimization decisions, enabling practitioners to understand and validate the reasoning behind hyperparameter adjustments.
Dynamic Strategy Adjustment: The system adapts its optimization approach based on observed training progress, unlike fixed algorithmic approaches that follow predetermined optimization protocols regardless of training dynamics.
Comprehensive Training Context Integration: this disclosure considers multiple aspects of training behavior simultaneously, including loss patterns, gradient dynamics, computational resource utilization, and training timeline constraints.

### Machine Learning Framework Integration Implementations:

This disclosure enables comprehensive integration mechanisms for major machine learning frameworks, enabling broad applicability across the machine learning ecosystem. In PyTorch integration embodiments, the system interfaces with PyTorch's training loop mechanisms through several approaches. In one approach, the system implements custom PyTorch hooks that execute at epoch boundaries or specified training iterations. These hooks access training metrics from the model and optimizer objects, format the metrics according to the communication protocol, transmit them to the language model component, receive optimization recommendations, and apply hyperparameter modifications to optimizer parameters, learning rate schedulers, or model configurations.

In an alternative PyTorch integration approach, the system extends PyTorch's Lightning framework by implementing custom callbacks that integrate with Lightning's training lifecycle. The callbacks automatically capture training and validation metrics at appropriate points in the training process, communicate with the language model component, and apply recommended modifications through Lightning's standardized interfaces. This integration approach leverages Lightning's built-in support for distributed training, multi-GPU execution, and cloud platform integration.

In TensorFlow integration embodiments, the system interfaces with TensorFlow's training mechanisms through the tf.keras.callbacks API. Custom callback classes inherit from tf.keras.callbacks. Callback and override methods such as on_epoch_end( ), on_batch_end( ), or on_train_batch_end( ), to capture training metrics at appropriate intervals. The callbacks access metrics from the training history, logs, and model state, communicate with the language model component, and implement hyperparameter modifications through TensorFlow's optimizer APIs, learning rate schedule objects, or model configuration parameters.

In JAX integration embodiments, the system leverages JAX's functional programming paradigm and transformation functions. The training loop explicitly calls language model integration functions at appropriate points, passing training state including model parameters, optimizer state, and performance metrics. The integration functions return modified optimizer states and hyperparameters that the training loop applies for subsequent training iterations. This functional approach aligns with JAX's design philosophy and enables compatibility with JAX's just-in-time compilation and automatic differentiation features.

In custom training loop embodiments, the system provides library interfaces that research practitioners and specialized training systems can integrate directly into their training code. These interfaces accept training metrics in flexible formats, communicate with language model components through configurable protocols, and return hyperparameter recommendations in structured formats that training code can parse and apply according to custom implementation requirements.

Operational Environment Coverage and Deployment Scenarios: this disclosure operates across diverse computing environments, providing consistent optimization capabilities regardless of deployment architecture. In local development environment embodiments, the system operates on individual developer workstations where practitioners develop and test machine learning models. The language model component may execute locally using small language models optimized for resource-constrained environments, or communicate with cloud-based language model services via internet connections. Local deployment minimizes communication latency for rapid iteration during model development while providing practitioners with immediate optimization feedback during exploratory training runs.

In cloud computing environment embodiments, the system operates within cloud platforms such as Amazon Web Services, Google Cloud Platform, Microsoft Azure, or specialized machine learning cloud services. Training processes execute on cloud virtual machine instances, container orchestration services, or managed machine learning training services. The language model component operates as a cloud service, either using cloud provider native artificial intelligence services or custom language model deployments on cloud infrastructure. Cloud deployment enables elastic scaling of both training and optimization components, automatic resource provisioning based on workload demands, and integration with cloud-native monitoring, logging, and alerting services.

In edge computing environment embodiments, the system operates on edge devices with limited computational resources, network bandwidth, or connectivity reliability. Edge deployment scenarios include training on mobile devices, embedded systems, Internet of Things devices, or edge servers in distributed computing architectures. The system employs optimization strategies tailored for resource-constrained environments, including local execution of small language models with reduced parameter counts, intermittent connectivity patterns where optimization requests are queued during network outages and processed when connectivity is restored, and aggressive caching of optimization recommendations to minimize network communication requirements.

In distributed computing cluster embodiments, the system coordinates optimization across multiple training nodes in high-performance computing clusters or distributed training architectures. Training processes execute across multiple compute nodes, potentially training different models simultaneously or training a single model using data parallelism or model parallelism techniques. The optimization system provides both per-node optimization where individual training processes receive independent optimization recommendations tailored to their specific training metrics, and cluster-wide optimization where the system analyzes aggregate metrics across all training nodes and provides coordinated optimization strategies that maintain consistency across the distributed training ensemble.

In hybrid environment embodiments, the system operates across multiple computing environments simultaneously. For example, training processes may execute in cloud environments while the language model component operates in on-premises data centers, or training may span both cloud and edge environments with centralized optimization coordination. Hybrid deployments require sophisticated network communication, security, and data synchronization mechanisms to maintain consistent operation across heterogeneous computing infrastructure.

Application Domain Breadth and Vertical-Specific Embodiments: this disclosure enables optimization capabilities across diverse machine learning application domains, with specialized embodiments for vertical-specific requirements. In foundation model fine-tuning embodiments, the system optimizes the training of large pre-trained language models, vision models, or multimodal models using parameter-efficient fine-tuning techniques. The system optimizes Low-Rank Adaptation (LoRA) hyperparameters including rank values that control the dimensionality of low-rank matrices, scaling factors (alpha parameters) that control the influence of adapted parameters, and module selection strategies that determine which model components receive LoRA adaptations. For Quantized Low-Rank Adaptation (QLoRA) training, the system optimizes quantization bit depths, quantization schemes, and the interplay between quantization parameters and adaptation parameters. The system analyzes training metrics specific to fine-tuning scenarios such as catastrophic forgetting indicators that measure the retention of pre-trained knowledge, adaptation effectiveness metrics that quantify task-specific performance improvements, and computational efficiency measures that assess the resource requirements of fine-tuning approaches.

In computer vision training embodiments, the system optimizes training of convolutional neural networks, vision transformers, or hybrid vision architectures for tasks including image classification, object detection, semantic segmentation, or generative image modeling. The system considers vision-specific training metrics including per-class accuracy distributions that identify classes requiring additional training emphasis, spatial error patterns that reveal localization or segmentation challenges, and data augmentation effectiveness measures that assess the contribution of augmentation strategies to model generalization. Optimization recommendations include adjustment of data augmentation hyperparameters such as rotation ranges, scaling factors, and color jittering parameters, modification of architecture-specific parameters including convolutional kernel sizes, attention head configurations in vision transformers, or feature pyramid network parameters, and tuning of vision-specific regularization techniques.

In natural language processing embodiments, the system optimizes training of language models, sequence-to-sequence models, or text classification architectures. The system analyzes NLP-specific metrics including perplexity values, BLEU scores for translation tasks, or task-specific evaluation metrics such as named entity recognition F1 scores. Optimization strategies consider NLP-specific challenges including vocabulary size effects on model capacity and training efficiency, sequence length impacts on computational requirements and model performance, and attention mechanism configurations that affect the model's ability to capture long-range dependencies in text data.

In reinforcement learning embodiments, the system optimizes training of policy networks, value functions, or actor-critic architectures. The system analyzes reinforcement learning metrics including cumulative reward, episode length, exploration-exploitation balance indicators, and policy stability measures. Optimization recommendations address reinforcement learning specific hyperparameters including exploration rates that control the balance between exploring new strategies and exploiting learned policies, discount factors that determine the importance of long-term versus short-term rewards, and experience replay parameters that affect the stability and sample efficiency of learning algorithms.

In federated learning embodiments, the system coordinates optimization across distributed training participants while respecting privacy constraints and communication limitations. The system analyzes federated-specific metrics including per-client training performance, model aggregation effectiveness, communication round efficiency, and privacy-utility tradeoffs. Optimization strategies include adjustment of local training hyperparameters on individual federated clients, coordination of aggregation frequencies and strategies, and dynamic resource allocation based on participant computational capabilities and network connectivity characteristics.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

This disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, a chemical molecule, a chemical composition, or any suitable combination or equivalent of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Although various embodiments have been depicted and described in detail herein, skilled artisans know that various modifications, additions, substitutions and the like can be made without departing from this disclosure. As such, these modifications, additions, substitutions and the like are considered to be within this disclosure.

1. A method, comprising:
executing, by a processing unit, a running training process that trains a machine learning model using a plurality of hyperparameters and a plurality of model weights, wherein the running training process processes a plurality of training data samples and a plurality of validation data samples in a sequence of epochs, and wherein each epoch in the sequence of epochs is a completed pass through the plurality of training data samples and the completed pass respectively produces a plurality of performance metrics for that epoch;
receiving, by the processing unit, during at least one epoch of the sequence of epochs, the plurality of performance metrics from the running training process at or after an epoch boundary in the sequence of epochs, wherein the plurality of performance metrics comprises a training metric computed from the plurality of training data samples and a validation metric computed from the plurality of validation data samples for the epoch boundary, and wherein the epoch boundary corresponds to the completed pass through the plurality of training data samples;
generating, by the processing unit, during the at least one epoch of the sequence of epochs, a message in natural language from the plurality of performance metrics for the epoch boundary, wherein the message in natural language describes the completed pass through the plurality of training data samples and the training metric and the validation metric for the epoch boundary;
defining, by the processing unit, during the at least one epoch of the sequence of epochs, a format definition that specifies a control identifier, an action type, and an action value for a structured format, wherein the format definition defines the structured format for the control identifier, the action type, and the action value;
providing, by the processing unit, during the at least one epoch of the sequence of epochs, the message in natural language and an instruction to produce a proposed change to a hyperparameter in the plurality of hyperparameters of the running training process in the structured format to a large language model, wherein the instruction commands the large language model to generate the control identifier, the action type, and the action value in the structured format;
receiving, by the processing unit, during the at least one epoch of the sequence of epochs, a response in the structured format from the large language model, wherein the response comprises the control identifier, the action type, and the action value that encode the proposed change to the hyperparameter in the plurality of hyperparameters of the running training process;
selecting, by the processing unit, during the at least one epoch of the sequence of epochs, a content from the response in the structured format that conforms to the format definition, wherein the content comprises the control identifier, the action type, and the action value that conform to the format definition;
issuing, by the processing unit, during at least one epoch of the sequence of epochs, a pause command to the running training process at the epoch boundary in the sequence of epochs, wherein the pause command is issued after the completed pass through the plurality of training data samples;
persisting, by the processing unit, a checkpoint that stores a training state that comprises the plurality of model weights and an optimizer state from the running training process responsive to the pause command, wherein the checkpoint is associated with the completed pass through the plurality of training data samples;
modifying, by the processing unit, the hyperparameter in the plurality of hyperparameters of the running training process according to the content from the response in the structured format, wherein the hyperparameter in the plurality of hyperparameters is modified after the completed pass through the plurality of training data samples;
restoring, by the processing unit, the checkpoint that stores the training state that comprises the plurality of model weights and the optimizer state after modifying the hyperparameter in the plurality of hyperparameters, wherein the checkpoint is restored after the completed pass through the plurality of training data samples;
issuing, by the processing unit, a resume command to the running training process after restoring the checkpoint that stores the training state, wherein the resume command initiates a next completed pass through the plurality of training data samples in the sequence of epochs; and
maintaining, by the processing unit, the machine learning model without reinitialization after issuing the resume command, wherein the machine learning model is maintained without reinitialization to preserve the plurality of model weights for the next completed pass.

2. The method of claim 1, further comprising:
comparing, by the processing unit, the training metric and the validation metric in the plurality of performance metrics for the epoch boundary to determine a deterioration; and
enforcing, by the processing unit, a restore prohibition that forbids restoring the training state to a same checkpoint more than once after a restore that did not increase the validation metric in a subsequent epoch.

3. The method of claim 1, further comprising:
measuring, by the processing unit, an analysis duration for the generating of the message in natural language and for the selecting of the content; and
terminating, by the processing unit, the generating of the message in natural language and the selecting of the content at a maximum duration that is a fraction of an epoch duration.

4. The method of claim 1, further comprising:
retrieving, by the processing unit, an approved list of hyperparameter names from the plurality of hyperparameters of the running training process; and
rejecting, by the processing unit, a block in the response in the structured format based on a control identifier in the block being absent from the approved list.

5. The method of claim 1, further comprising:
setting, by the processing unit, a minimum number of epochs after the modifying of the hyperparameter in the plurality of hyperparameters; and
initiating, by the processing unit, a next providing of the message in natural language and the instruction to the large language model at an epoch count that equals a current epoch count plus the minimum number of epochs.

6. The method of claim 1, further comprising:
restoring, by the processing unit, the checkpoint that stores the training state from an earlier epoch boundary; and
adding, by the processing unit, a layer to the machine learning model before issuing the resume command.

7. The method of claim 1, further comprising:
marking, by the processing unit, a preexisting layer in the machine learning model as not trainable for a period; and
unfreezing, by the processing unit, the preexisting layer in the machine learning model after the period.

8. The method of claim 1, further comprising:
computing, by the processing unit, a window of epochs since a most recent modifying of the hyperparameter in the plurality of hyperparameters; and
limiting, by the processing unit, the generating of the message in natural language to the plurality of performance metrics within the window.

9. The method of claim 1, further comprising:
selecting, by the processing unit, a percentage of the sequence of epochs as a recent subset; and
limiting, by the processing unit, the generating of the message in natural language to the plurality of performance metrics within the recent subset.

10. The method of claim 1, further comprising:
receiving, by the processing unit, a user response in the structured format that comprises the control identifier, the action type, and the action value; and
applying, by the processing unit, the modifying of the hyperparameter in the plurality of hyperparameters according to the user response in the structured format.

11. The method of claim 1, further comprising:
enforcing, by the processing unit, a multiply action for a numeric hyperparameter based on the action type in the content being multiply; and
enforcing, by the processing unit, a set action for a categorical hyperparameter based on the action type in the content being set.

12. The method of claim 1, further comprising:
setting, by the processing unit, a numeric bound for the action value in the format definition; and
rejecting, by the processing unit, an action value in the content that exceeds the numeric bound.

13. The method of claim 1, further comprising:
recording, by the processing unit, a restore count for a checkpoint that stores the training state; and
preventing, by the processing unit, restoring the training state to the checkpoint based on the restore count exceeding a threshold.

14. The method of claim 1, further comprising:
comparing, by the processing unit, the analysis duration for the generating of the message in natural language with an epoch duration for the sequence of epochs; and
selecting, by the processing unit, an epoch boundary for issuing the pause command based on the comparison.

15. The method of claim 1, further comprising:
recording, by the processing unit, the response in the structured format together with an identifier of the epoch boundary; and
associating, by the processing unit, the recording with the modifying of the hyperparameter in the plurality of hyperparameters.

16. The method of claim 1, further comprising:
inserting, by the processing unit, a whitelist entry for the control identifier in the format definition responsive to a validation of the control identifier; and
excluding, by the processing unit, a block in the response in the structured format that comprises a control identifier absent from the whitelist entry.

17. The method of claim 1, further comprising:
setting, by the processing unit, a scale for the action value for a numeric hyperparameter; and
converting, by the processing unit, the action value in the content to a scaled value according to the scale before the modifying of the hyperparameter in the plurality of hyperparameters.

18. The method of claim 1, further comprising:
defining, by the processing unit, a mapping from the control identifier to a hyperparameter name in the plurality of hyperparameters; and
applying, by the processing unit, the modifying of the hyperparameter in the plurality of hyperparameters only based on the control identifier mapping to the hyperparameter name.

19. The method of claim 1, further comprising:
computing, by the processing unit, a trend over a plurality of performance metrics by linear regression across a set of epochs; and
appending, by the processing unit, a description of the trend to the message in natural language.

20. The method of claim 1, further comprising:
defining, by the processing unit, a maximum count of structured responses per epoch boundary; and
restricting, by the processing unit, the receiving of the response in the structured format to the maximum count per epoch boundary.

21. The method of claim 1, wherein the large language model provides a natural language explanation for each hyperparameter adjustment recommendation.

22. The method of claim 1, wherein the large language model analyzes a visual representation of a training curve to inform a hyperparameter decision.

23. The method of claim 1, wherein at least one hyperparameter of the plurality of hyperparameters is adjusted via dynamic modification of model architecture parameters during the training process.

24. A method, comprising:
executing, by a processing unit, a running training process that trains a machine learning model using a plurality of hyperparameters and a plurality of model weights, wherein the running training process processes a plurality of training data samples and a plurality of validation data samples in a sequence of epochs;
receiving, by the processing unit, during at least one epoch of the sequence of epochs, a plurality of performance metrics from the running training process during an active training session, wherein the plurality of performance metrics comprises a training metric computed from the plurality of training data samples and a validation metric computed from the plurality of validation data samples;
generating, by the processing unit, during the at least one epoch of the sequence of epochs, a message in natural language from the plurality of performance metrics, wherein the message in natural language describes the training metric and the validation metric during the active training session;
preparing, by the processing unit, during the at least one epoch of the sequence of epochs, an instruction that requests a proposed change to a hyperparameter in the plurality of hyperparameters for the running training process;
submitting, by the processing unit, during the at least one epoch of the sequence of epochs, the message in natural language and the instruction to a large language model;
receiving, by the processing unit, during the at least one epoch of the sequence of epochs, a recommendation from the large language model, wherein the recommendation encodes a proposed change to the hyperparameter in the plurality of hyperparameters;
issuing, by the processing unit, during the at least one epoch of the sequence of epochs, a pause command to the running training process during the active training session;
persisting, by the processing unit, a training state that comprises the plurality of model weights and an optimizer state from the running training process responsive to the pause command;
modifying, by the processing unit, the hyperparameter in the plurality of hyperparameters of the running training process according to the recommendation;
restoring, by the processing unit, the training state that comprises the plurality of model weights and the optimizer state after the hyperparameter in the plurality of hyperparameters is modified;
issuing, by the processing unit, a resume command to the running training process after the training state is restored to continue the sequence of epochs; and
maintaining, by the processing unit, the machine learning model without reinitialization after the resume command is issued.

25. A method, comprising:
executing, by a processing unit, a running training process that trains a machine learning model using a plurality of hyperparameters and a plurality of model weights, wherein the running training process processes a plurality of training data samples and a plurality of validation data samples in a sequence of epochs;
receiving, by the processing unit, during at least one epoch of the sequence of epochs, a plurality of performance metrics from the running training process during an active training session, wherein the plurality of performance metrics comprises a training metric computed from the plurality of training data samples and a validation metric computed from the plurality of validation data samples;
generating, by the processing unit, during the at least one epoch of the sequence of epochs, a message in natural language from the plurality of performance metrics, wherein the message in natural language describes the training metric and the validation metric during the active training session;
preparing, by the processing unit, during the at least one epoch of the sequence of epochs, an instruction that requests a proposed change to a hyperparameter in the plurality of hyperparameters for the running training process;
providing, by the processing unit, during the at least one epoch of the sequence of epochs, the message in natural language and the instruction to a large language model;
receiving, by the processing unit, during the at least one epoch of the sequence of epochs, a control output from the large language model, wherein the control output encodes a proposed change to the hyperparameter in the plurality of hyperparameters;
modifying, by the processing unit, during the at least one epoch of the sequence of epochs, the hyperparameter in the plurality of hyperparameters of the running training process according to the control output during the active training session; and
continuing, by the processing unit, the sequence of epochs after while maintaining the machine learning model without reinitialization to preserve the plurality of model weights.

26. A method for optimizing a training process of a machine learning model during the training process, the method comprising:
monitoring, by a processing unit, during an epoch, a plurality of training metrics during the training process of the machine learning model;
providing, by the processing unit, during the epoch, the plurality training metrics to a large language model during the training process of the machine learning model;
receiving, by the processing unit, during the epoch, a plurality of hyperparameter modification instructions from the large language model during the training process of the machine learning model; and
implementing, by the processing unit, during the epoch, the plurality of hyperparameter modification instructions to adjust the training process during the training process of the machine learning model.

27. The method of claim 26, wherein the plurality of hyperparameter modifications include an optimization of at least one of a learning rate, a batch size, an optimization algorithm, a regularization parameter, or a model architecture parameter.
